(19) United States
(12) Patent Application Publication
(10) Pub. No.: US 2021/0065089 A1
(43) Pub. Date: Mar. 4, 2021

(54) ERRAND PLOTTER SYSTEM AND METHOD

(71) Applicant: Cerence Operating Company, Burlington, MA (US)

(72) Inventors: Carie CUNNINGHAM, Ferndale, MI (US); Gerald Kingsley DUNN, III, Royal Oak, MI (US)

(21) Appl. No.: 16/555,260

(22) Filed: Aug. 29, 2019

(51) Int. Cl. G06Q 10/06; G01C 21/36; G01C 21/34

(52) U.S. Cl. CPC G06Q 10/06316; G06Q 10/0633; G01C 21/3415; G01C 21/343; G01C 21/3641

(57) ABSTRACT

A system and method for an errand plotter considers user criteria to generate an optimized errand plot for an errand involving one or more tasks at one or more locations. A computing device obtains a plurality of tasks input by a user. Each task has an associated location and associated user criteria. User criteria associated with each task is analyzed to determine which tasks of the plurality of tasks have a temperature sensitive attribute or a user defined urgency attribute. A task sequence is determined by arranging the tasks of the plurality of tasks that have user defined urgency attribute first, tasks of the plurality of tasks that have a temperature sensitive attribute last, and the remaining tasks of the plurality of tasks therebetween. The computing device generates an errand plot based on the determined task sequence.

### BACKGROUND

### 1. Field of the Disclosure

The present disclosure relates an errand plotter. More particularly, the present disclosure relates to such an errand plotter that considers user criteria to generate an optimized errand plot for an errand involving one or more tasks at one or more locations.

### 2. Description of Related Art

Navigation systems use Global Positioning System (GPS) technology to determine at least one traversable route between a start location and an end location. After a user inputs start location data and end location data, the navigation system calculates the route. Navigation systems can also output instructions for the user to follow as audio from a speaker or as images from a display.

Navigation systems also function in part to reduce or minimize the distance traveled or time spent traveling. Typical route selection problems considered include, for example, number of turns, number of lights, number of intersections, distances, speed limits, bridge crossings, tolls, railroad crossings.

As used herein, an errand is a short trip away from a person's home involving one or more tasks at one or more locations. An example of one or more locations is a bank and a laundromat.

As used herein, a task is a specific amount of work or set of actions that when undertaken will accomplish a specific purpose or objective. Examples of tasks include depositing cash and picking up laundry.

Thus, a trip driving to the bank and the act of depositing money or a trip driving to the laundromat and the act of picking up laundry are examples of errands.

An example of an errand series is a person driving from their home to a local grocery store and buying milk, driving from the grocery store to their dry cleaner and picking up laundry, driving from their dry cleaner to their bank and depositing a check, driving from their bank to the local soccer field and picking up their child from practice, driving from the soccer field to the local post office and mailing a letter, and ultimately driving home.

When running errands, a navigation system can facilitate guiding a person from one location to another.

To be effective at running errands and to save money on gas, a person must complete as many tasks per errand series as possible. To do so requires extensive planning with respect to generating a list of destinations in an order so that the tasks can be performed in a preferred, optimal sequence that accounts for third party schedule limitations. Third party schedule limitations are those over which the person has no control. An example of a third-party schedule limitation is soccer practice, which is at a fixed time. Another example of a third-party schedule limitation is a bank that is closed in the afternoon.

After the sequence of destinations corresponding to the tasks is determined by the person, each can be input into the navigation system. Thus, even with a navigation system, errand running requires significant cognitive exertion and can cause a person stress. Not only, because the person programmed the navigation system to go to the grocery store first, because the outdoor temperature was in the high 30's (Celsius), and because the errand duration was over three hours, the milk that was purchased was ruined before the person even arrived home. Current systems fail to account for the several mental factors that are traditionally accounted for by a user, including urgency, third party schedule limitations, temperature sensitive cargo or related attributes, and multi-tasking capabilities.

### SUMMARY OF THE DISCLOSURE

The present disclosure provides a system and method for generating an optimized errand plot for an errand involving one or more tasks at one or more locations.

The present disclosure further provides a system and method for an errand plotter that considers user criteria to generate an optimized errand plot.

The plurality of tasks is obtained by at least one input process selected from the group consisting of: voice, haptic, connected device, and connected cloud.

The present disclosure still further provides such as system and method that detects a presence of temperature sensitive cargo with a temperature sensor and alerts the user.

The present disclosure still further provides such as system and method that updates the errand plot to route the user home when temperature sensitive cargo is detected.

The present disclosure still further provides such as system and method that supplements each task with location and/or time from one or more cloud databases.

The present disclosure still further provides such as system and method that outputs the errand plot to a display device or a navigation system.

A computing device obtains a plurality of tasks input by a user. Each task has an associated location and associated user criteria. User criteria associated with each task is analyzed to determine which tasks of the plurality of tasks have a temperature sensitive attribute or a user defined urgency attribute. A task sequence is determined by arranging the tasks of the plurality of tasks that have user defined urgency attribute first, tasks of the plurality of tasks that have a temperature sensitive attribute last, and the remaining tasks of the plurality of tasks therebetween. The computing device generates an errand plot based on the determined task sequence.

### BRIEF DESCRIPTION OF THE FIGURES

The accompanying drawings illustrate aspects of the present disclosure, and together with the general description given above and the detailed description given below, explain the principles of the present disclosure. As shown throughout the drawings, like reference numerals designate like or corresponding parts.

FIG. 1 shows an exemplary system architecture for an errand plotter system according to the present disclosure.

FIG. 2 shows an exemplary method of the errand plotter system.

### DETAILED DESCRIPTION

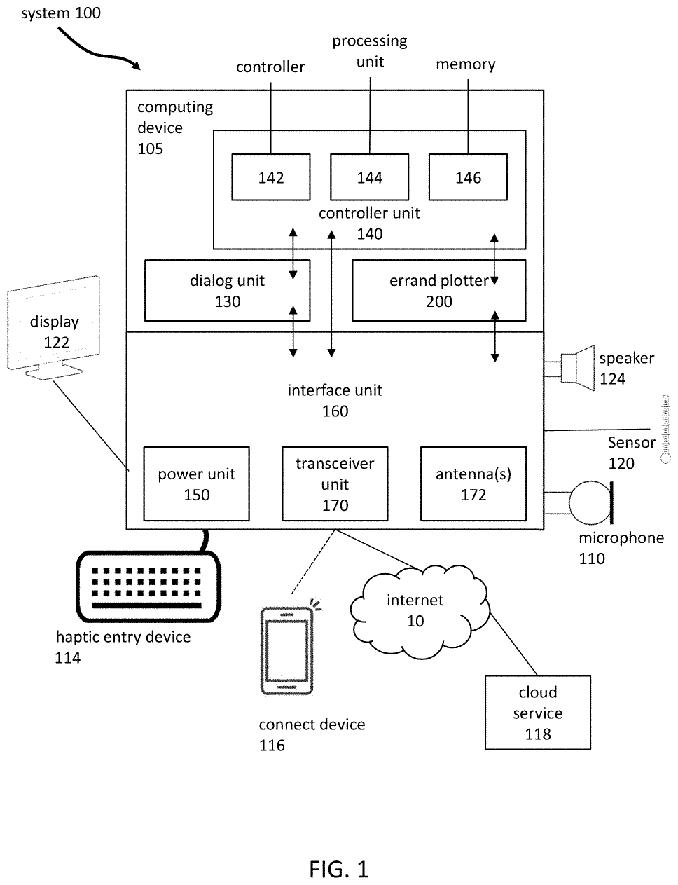

Referring to the drawings and, in particular to FIG. 1, an example system architecture for a dynamic errand plotting navigation system is generally represented by reference numeral 100, hereinafter “system 100”. System 100 includes errand plotter 200 that generates an errand plot based on sequence determination calculated from a task set input by a user.

As used herein, an errand plot is an ordered pattern of locations based on tasks to be performed during the errand.

As discussed above, a task is a specific amount of work or set of actions that when undertaken will accomplish a specific purpose or objective. Examples of tasks include depositing cash or picking up laundry.

Some tasks have associated user criteria or preferences.

Appointments are tasks that have a predetermined start and/or end time. An example is a doctor's appointment because the appointment has a predetermined start time.

Important tasks are those that a user wants to prioritize and have a user defined urgency. An example is filling the car with gas. Because the tank is low, the user wants this task done as early in the errand as possible to avoid car trouble.

Temperature sensitive tasks are tasks that must be completed as quickly as possible to avoid detrimental thermal effects to the specific purpose or objective of the task. Temperature sensitive tasks can involve temperature sensitive cargo. An example is buying an ice cream cake. An ice cream cake must be kept cold to maintain its integrity and structure. Thus, this task has a temperature related attribute. A user wants this task done at the end of the errand so that the ice cream cake can be transported home as quickly as possible, thereby preventing a large temperature change.

Accordingly, as used herein, user criteria include a start and/or end time, a temperature related attribute, and user defined urgency.

System 100 includes the following exemplary components that are electrically and/or communicatively connected: a computing device 105, a microphone 110, a haptic entry device 114, a connect device 116, a cloud service 118, a sensor 120, a display 122, and a speaker 124.

Computing device 105 can include the following: an errand plotter 200, a dialogue unit 130; a controller unit 140, which can be configured to include a controller 142, a processing unit 144 and/or a non-transitory memory 146; a power unit 150 (e.g., battery or AC-DC converter); an interface unit 160, which can be configured as an interface for external power connection and/or external data connection such as with input/output devices including microphone 110, haptic entry device 114, connect device 116, cloud service 118, sensor 120, display 122, and speaker 124; a transceiver unit 170 for wireless communication; and antenna(s) 172. The components of computing device 105 can be implemented in a distributed manner and across one or more networks, wired or wireless, such as personal area networks, local area networks, wide area networks, or the internet 10. For example, cloud service 118 is in communication via internet 10.

Dialogue unit 130 is a dialogue system that converses with a user by receiving and processing audio from microphone 110 and outputting a response from speaker 124. Dialogue unit 130 includes, in example embodiments, automatic speech recognition (ASR), natural language understanding (NLU), dialogue management (DM), natural language generation (NLG), and text-to-speech (TTS), in software and/or hardware.

Microphone 110 is a transducer that converts sound into an electrical signal. Typically, a microphone utilizes a diaphragm that converts sound to mechanical motion that is in turn converted to an electrical signal. Several types of microphones exist that use different techniques to convert, for example, air pressure variations of a sound wave into an electrical signal. Nonlimiting examples include: dynamic microphones that use a coil of wire suspended in a magnetic field; condenser microphones that use a vibrating diaphragm as a capacitor plate; and piezoelectric microphones that use a crystal of made of piezoelectric material. Microphone 110 can be one or more microphones or microphone arrays. A microphone according to the present disclosure can also include a radio transmitter and receiver for wireless applications.

Haptic entry device 114 is a text entry input device for computing device 105. A keyboard is an example of a haptic entry device.

Connect device 116 is a physical object, such as a phone, that is physically located in the car, but can access both information local to the object and cloud-based information through the object. Example connect devices 116 include multi-purpose mobile computing devices like smart phones or tablets through a wired or wireless connection to transfer data between interface 160 and connect device 116. The wired connected could be through a universal serial bus (USB) cable or any other connection that allows connectivity to the car.

Cloud service 118 is a web-based server that exists outside of the car to rely on information from external data sources and content services.

Sensor 120 is one or more sensors used to detect the presence of temperature sensitive items in a vehicle. For example, sensor 120 can be disposed in the trunk or passenger compartment of a car and configured to detect the presence of groceries.

In example embodiments, sensor 120 can be integrated in an automobile vehicle computer system in operative communication with system 100.

Nonlimiting examples of sensor 120 include a temperature sensor, a force sensor such as a load cell, and a proximity sensor.

Example temperature sensors include negative temperature coefficient thermistors, resistance temperature detectors, thermocouples, and semi-conductor-based sensors.

Example combinations of sensor 120 include: a temperature sensor; a temperature sensor and a force sensor; and a temperature sensor, a force sensor, and a proximity sensor.

Display 122 is an electronic output device comprising circuitry for visually presenting data or information from computing device 105. Examples include LED and LCD panels.

Speaker 124 is an electroacoustic transducer generally known as a loudspeaker. Speaker 124 converts an electrical audio signal from computing device 105 into a corresponding sound.

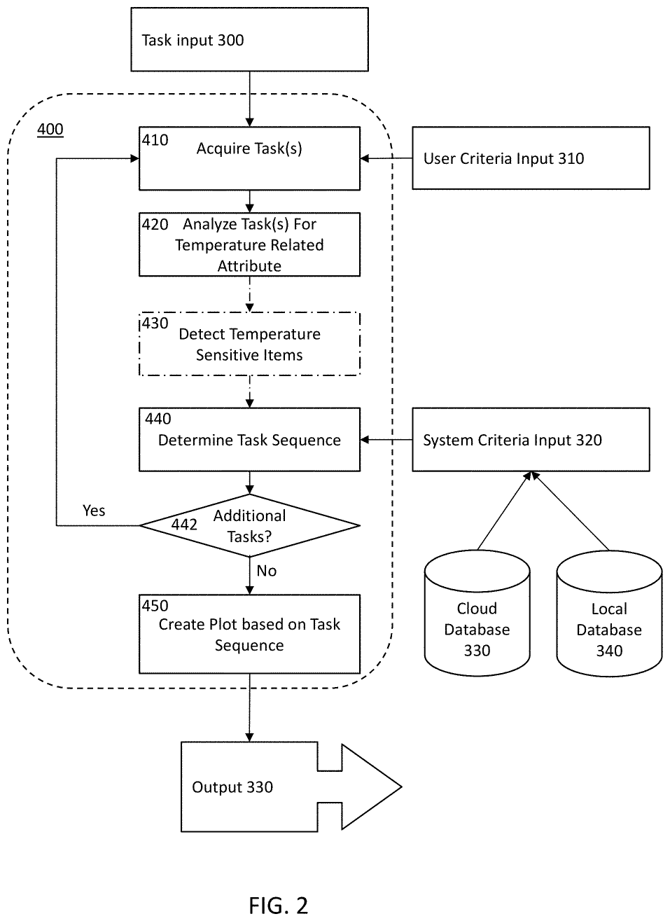

An example operation of errand plotter 200, method 400, will now be described with reference to FIG. 2.

A user will engage system 100 and provide task input 300 and user criteria input 310 from an input device such as microphone 110, haptic entry device 114, connect device 116, or cloud service 118.

Although it may be practical to input multiple tasks via the same method, task input 300 and user criteria input 310 can be from any combination of input devices. Advantageously, this affords the user flexibility if the tasks need to be updated or added to at a later time and the environment changes. For example, if a user first inputs a task by haptic entry, and later wants to add a task while carrying groceries, a second input can be by voice entry.

Task input 300 and user criteria input 310 by voice entry operates as follows. A user speaks a command into microphone 110. The command includes a task, and optionally, user criteria. Microphone 110 sends a speech signal of the command to dialog unit 130. Dialog unit 130, through NLU identifies the task, intent and details relating to the task, and/or user criteria for the task.

In one example, a user speaks “pick up kids from karate”. Dialog unit identifies the task as an appointment having a fixed start or end time. Thus, a start and/or end time are determined to be user criteria. Dialog unit also identifies location to be that of karate lessons. As will be discussed below, the missing information, namely location and start and/or end time, will be supplied by system 100 in a later step.

Task input 300 by haptic entry device 114 operates as follows. A user engages system 100 with haptic entry device 114 and inputs a command. The command includes a task and optionally, user criteria. Dialog unit 130, through NLU identifies the task, intent and details relating to the task, and/or user criteria for the task.

In example embodiments, system 100 provides a visual user interface through display 122. The user interface displays a plurality of selectable tasks and user criteria that a user can select using haptic entry device 114.

In one example, a user types, “get oil change”. Dialog unit 130 identifies the task to be changing oil and the location to be that of an auto mechanic shop. Again, as will be discussed below, the missing information, namely location, will be supplied by system 100 in a later step.

Task input 300 by connected device 116 operates as follows. Computing device 105 communicates with connected device 116 by a wired or wireless connection. Task, task location and user criteria are communicated.

Task input 300 by cloud service 118 operates as follows. Computing device 105 communicates with cloud service 118. Task, task location and user criteria are communicated.

Method 400 of errand plotter 200 commences at step 410 by acquiring the task, applicable user criteria including a start and/or end time, a temperature related attribute, and user defined urgency for the task, and if available, a location for the task.

At step 420 the task is analyzed for a temperature related attribute. The task has a temperature related attribute if the task location is a grocery store, if the task involves food, or if the user inputs such as user criteria. If a temperature related attribute is present, the task is identified as being temperature sensitive.

At step 430, errand plotter detects whether temperature sensitive items are present using data obtained by sensor 120.

In an example embodiment, temperature sensitive item detection is done by monitoring the internal temperature of the car. If system 100 detects that the trunk and/or car gets suddenly cold after a stop, then the system assumes that there are cold items in the car that need to be removed as quickly as possible.

In example embodiments, step 430 is optional.

At step 440, a task sequence is determined based on the temperature related attribute analysis, the temperature sensitive item detection, and system criteria input 320, which are the criteria used by system 100 to determine a route and sequence for the user to run the errand.

System criteria input 320 includes one or more of: increasing righthand turns, historical routes, traffic, opening and closing times, appointment/event, geographical distance, task dependency, temporal immediacy, weather conditions, cost, and multi-tasking domains.

System criteria input 320 also supplies missing task location or appointment information including start/end times as discussed above or open/close times of a business.

The task sequence is generated by first factoring the user considerations.

Tasks with user defined urgency are arranged at the beginning of the task list. Appointments and tasks without user criteria are arranged next in the list, with appointments arranged based on their predetermined time. Tasks with temperature sensitive attributes are arranged at the end of the task list.

A shortest path problem or a variation thereof between locations of the tasks with temperature sensitive attributes is solved using system criteria input 320. A shortest path problem variation or variation thereof between locations of the tasks with user defined urgency is solved using system criteria input 320. A shortest path problem or variation thereof between the remaining locations is solved.

The solutions are concatenated to determine the errand plot.

Increasing righthand turns is a factor of routing that prioritizes routes that have more righthand turns over other routes that have more left-hand turns or Michigan lefts. This route information is available via a cloud database 330 or embedded database 340 with mapping information.

Historical route is a factor of routing that prioritizes routes that are used routinely. This historical route information is available via a cloud database 330 or embedded database 340 with mapping information.

Traffic is a factor of routing that prioritizes routes that do not have congested traffic. The traffic information is available via a cloud database 330 with mapping and traffic information.

The opening and closing times are the times when the location for a task that is a business/store is open. The open and closing times are determined from cloud database 330 or embedded database 340.

Appointment is a system consideration of a user criteria where there is a specific task that has time and location constraints. Appointment information is available via cloud database 330 or embedded database 340 through a calendar system. Such appointment information includes opening and closing times, calendar appointments, or other related information that can fix a time and location to a task.

The geographical distance is a factor of routing that prioritizes spatial distance in mapping. This route information is available via cloud database 330 or embedded database 340 with mapping information.

Task dependency is a consideration where tasks are ordered based on their dependency to other tasks. Stated another way, a first task depends on a second task. For example, a parent cannot drop off a child at daycare until after first picking up the child from school. Thus, the daycare task is dependent on or second to the first task of picking up the child from school. This information is gathered via cloud database 330 or embedded database 340.

Temporal immediacy is a system consideration where temporal immediacy means that a task needs to be done at a certain, specific time. This could be an appointment or other task that has time constraints. This information can be gathered by either cloud or embedded databases through calendars, opening and closing times, appointments, or other related information that can fix a time to a task.

Weather conditions is a system consideration where weather conditions mean weather related hazards specifically ones that will impact driving. In example embodiments, system 100 should avoid weather related hazards to keep the driver safe and allow the errand to continue. This weather condition information is available via cloud database 330 with weather and mapping information.

Cost is a system consideration that considers the monetary loss for each route and prioritizes routes that have the least monetary loss through fuel consumption in mapping. This route information is available via cloud database 330 or embedded database 340 with mapping information.

If there are additional tasks to be added at decision block 442, method 400 returns to step 410 to acquire one or more additional tasks. In practice, this can occur when a user desires to add a task.

If there are no additional tasks to be added at decision block 442, method 400 continues.

At step 450 a plot or output 350 is generated based on the task sequence.

In example embodiments, output 350 can be fed into a navigation system to plan a complete route with stopovers/waypoints that comprise the full list of tasks for the errand. In other example embodiments, output 350 can be embedded in a map that is output to display 122. In still other example embodiments, an address for the current task can be output to display 122. It will be understood that output 350 can also be fed to connect device 116.

It should be understood that elements or functions of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

While the present disclosure has been described with reference to one or more exemplary embodiments, it will be understood by those skilled in the art, that various changes can be made, and equivalents can be substituted for elements thereof without departing from the scope of the present disclosure. In addition, many modifications can be made to adapt a particular situation or material to the teachings of the present disclosure without departing from the scope thereof. Therefore, it is intended that the present disclosure will not be limited to the particular embodiments disclosed herein, but that the disclosure will include all aspects falling within the scope of a fair reading of appended claims.

1. A computer-implemented method comprising:
obtaining, by a computing device, a plurality of tasks input by a user, each task having an associated location and associated user criteria,
analyzing associated user criteria for each task to determine which tasks of the plurality of tasks have a temperature sensitive attribute or a user defined urgency attribute;
determining a task sequence by arranging the tasks of the plurality of tasks that have user defined urgency attribute first, tasks of the plurality of tasks that have a temperature sensitive attribute last, and the remaining tasks of the plurality of tasks therebetween; and
generating, by the computing device, an errand plot in a sequence of the associated locations based on the determined task sequence.

2. The method according to claim 1, wherein the plurality of tasks are obtained by at least one input process selected from the group consisting of: voice, haptic, connected device, and connected cloud.

3. The method according to claim 1, further comprising: detecting a presence of temperature sensitive cargo with a temperature sensor; and alerting the user.

4. The method according to claim 3, further comprising: updating the errand plot to route the user home.

5. The method according to claim 1, further comprising: supplementing each task with location and/or time from a cloud database.

6. The method according to claim 1, further comprising: outputting the errand plot to a display device or a navigation system.

7. A computer program product residing on a non-transitory computer readable storage medium having a plurality of instructions stored thereon which, when executed across one or more processors, causes at least a portion of the one or more processors to perform operations comprising:
obtaining, by a computing device, a plurality of tasks input by a user, each task having an associated location and associated user criteria,
analyzing associated user criteria for each task to determine which tasks of the plurality of tasks have a temperature sensitive attribute or a user defined urgency attribute;
determining a task sequence by arranging the tasks of the plurality of tasks that have user defined urgency attribute first, tasks of the plurality of tasks that have a temperature sensitive attribute last, and the remaining tasks of the plurality of tasks therebetween; and
generating, by the computing device, an errand plot in a sequence of the associated locations based on the determined task sequence.

8. The computer program product according to claim 7, wherein the plurality of tasks are obtained by at least one input process selected from the group consisting of: voice, haptic, connected device, and connected cloud.

9. The computer program product according to claim 7, further comprising: detecting a presence of temperature sensitive cargo with a temperature sensor; and alerting the user.

10. The computer program product according to claim 9, further comprising: updating the errand plot to route the user home.

11. The computer program product according to claim 7, further comprising: supplementing each task with location and/or time from a cloud database.

12. The computer program product according to claim 7, further comprising: outputting the errand plot to a display device or a navigation system.

13. A computing system including one or more processors and one or more non-transitory memories storing program instructions that, when executed, perform operations comprising:
obtaining, by a computing device, a plurality of tasks input by a user, each task having an associated location and associated user criteria,
analyzing associated user criteria for each task to determine which tasks of the plurality of tasks have a temperature sensitive attribute or a user defined urgency attribute;
determining a task sequence by arranging the tasks of the plurality of tasks that have user defined urgency attribute first, tasks of the plurality of tasks that have a temperature sensitive attribute last, and the remaining tasks of the plurality of tasks therebetween; and
generating, by the computing device, an errand plot in a sequence of the associated locations based on the determined task sequence.

14. The computing system according to claim 13, wherein the plurality of tasks are obtained by at least one input process selected from the group consisting of: voice, haptic, connected device, and connected cloud.

15. The computing system according to claim 13, further comprising: detecting a presence of temperature sensitive cargo with a temperature sensor; and alerting the user.

16. The computing system according to claim 15, further comprising: updating the errand plot to route the user home.

17. The computing system according to claim 13, further comprising: supplementing each task with location and/or time from a cloud database.

18. The computing system according to claim 13, further comprising: outputting the errand plot to a display device or a navigation system.
